(19) United States
(12) Patent Application Publication
(10) Pub. No.: US 2026/0225261 A1
(43) Pub. Date: Aug. 6, 2026

(54) ROBOT HAND MECHANISM

(71) Applicant: Sony Group Corporation, Tokyo (JP)

(72) Inventor: Yoshinao SODEYAMA, Tokyo (JP)

(73) Assignee: Sony Group Corporation, Tokyo (JP)

(21) Appl. No.: 19/155,573

(22) PCT Filed: Feb. 20, 2024
(86) PCT No.: PCT/JP2024/005916

§ 371 Date: Aug. 12, 2025

(30) Foreign Application Priority Data
Mar. 10, 2023 (JP) 2023-037369

(51) Int. Cl. B25J 15/00

(52) U.S. Cl. CPC B25J 15/0009

(57) ABSTRACT

A robot hand mechanism includes a main portion corresponding to a portion other than a thumb of a hand, a thumb portion corresponding to the thumb, a first rotation shaft that is parallel to a second direction perpendicular to a first direction in which the main portion extends and that flexes and extends the main portion in a first rotation direction, a second rotation shaft that is parallel to the first rotation shaft and that flexes and extends the main portion in the first rotation direction, and a third rotation shaft that is parallel to the first direction or inclined in an oblique direction with respect to the first direction about a third direction perpendicular to the first direction and the second direction and that rotates the thumb portion in a second rotation direction with respect to the main portion, and in a state with the main portion is extended.

### TECHNICAL FIELD

The present technology relates to a robot hand mechanism, and particularly relates to a robot hand mechanism that facilitates interaction with a person.

### BACKGROUND ART

There have been conventionally proposed robot hands having elasticity that makes humans feel comfortable and having a temperature close to body temperature of humans (see, for example, Patent Document 1).

### CITATION LIST

### Patent Document

Patent Document 1: Japanese Patent Application Laid-Open No. 2004-58188

### SUMMARY OF THE INVENTION

### Problems to be Solved by the Invention

A robot hand described in Patent Document 1, however, is fixed in a state where a thumb thereof is bent toward a palm side. Therefore, it can be difficult for a person to shake hands with the robot hand, and there is a risk that interaction with the person is impaired.

The present technology has been made in view of such circumstances, and achieves a robot hand mechanism that facilitates interaction with a person.

### Solutions to Problems

A robot hand mechanism according to an aspect of the present technology includes a main portion corresponding to a portion other than a thumb of a hand, a thumb portion corresponding to the thumb, a first rotation shaft that is parallel to a second direction perpendicular to a first direction in which the main portion extends and that flexes and extends the main portion in a first rotation direction, a second rotation shaft that is parallel to the first rotation shaft and that flexes and extends the main portion in the first rotation direction, and a third rotation shaft that is parallel to the first direction or inclined in an oblique direction with respect to the first direction about a third direction perpendicular to the first direction and the second direction and that rotates the thumb portion in a second rotation direction with respect to the main portion, in which in a state in which the main portion is extended, the first to third rotation shafts are arranged on a same plane.

In the aspect of the present technology, the main portion corresponding to the portion other than the thumb of the hand is flexed and extended in the first rotation direction, and the thumb portion corresponding to the thumb is rotated in the second rotation direction.

### BRIEF DESCRIPTION OF DRAWINGS

FIG. 1 is a front view and a left side view of a nursing care robot to which the present technology is applied.

FIG. 2 is a rear view of the nursing care robot.

FIG. 3 is a perspective view of the nursing care robot as viewed in a diagonally front-right direction.

FIG. 4 is a perspective view of the nursing care robot as viewed in a diagonally rear-left direction.

FIG. 5 is a diagram comparing sizes of the nursing care robot and a general table.

FIG. 6 is an enlarged view of a head portion of the nursing care robot.

FIG. 7 is an exploded view illustrating an internal configuration example of an eyeball portion of the nursing care robot.

FIG. 8 is an external view of an arm portion of the nursing care robot.

FIG. 9 is an external view of a hand of the nursing care robot.

FIG. 10 is an external view schematically illustrating a first modification of the hand of the nursing care robot.

FIG. 11 is another external view schematically illustrating the first modification of the hand of the nursing care robot.

FIG. 12 is another external view schematically illustrating the first modification of the hand of the nursing care robot.

FIG. 13 is an external view schematically illustrating a second modification of the hand of the nursing care robot.

FIG. 14 is an external view schematically illustrating a third modification of the hand of the nursing care robot.

FIG. 15 is another external view schematically illustrating the third modification of the hand of the nursing care robot.

FIG. 16 is a diagram illustrating an example of installation of sensors in the third modification of the hand of the nursing care robot.

FIG. 17 is an external view schematically illustrating a fourth modification of the hand of the nursing care robot.

FIG. 18 is an external view schematically illustrating a fifth modification of the hand of the nursing care robot.

FIG. 19 is an external view schematically illustrating a sixth modification of the hand of the nursing care robot.

FIG. 20 is an external view schematically illustrating a seventh modification of the hand of the nursing care robot.

FIG. 21 is a front view of the nursing care robot on which a hand display is mounted.

### MODE FOR CARRYING OUT THE INVENTION

An embodiment of the present technology will be described in detail hereinafter with reference to the drawings. Note that the description will be given in the following order.
1. Embodiment
2. Modifications
3. Others

### «1. Embodiment»

### <Configuration Example of Nursing Care Robot 11>

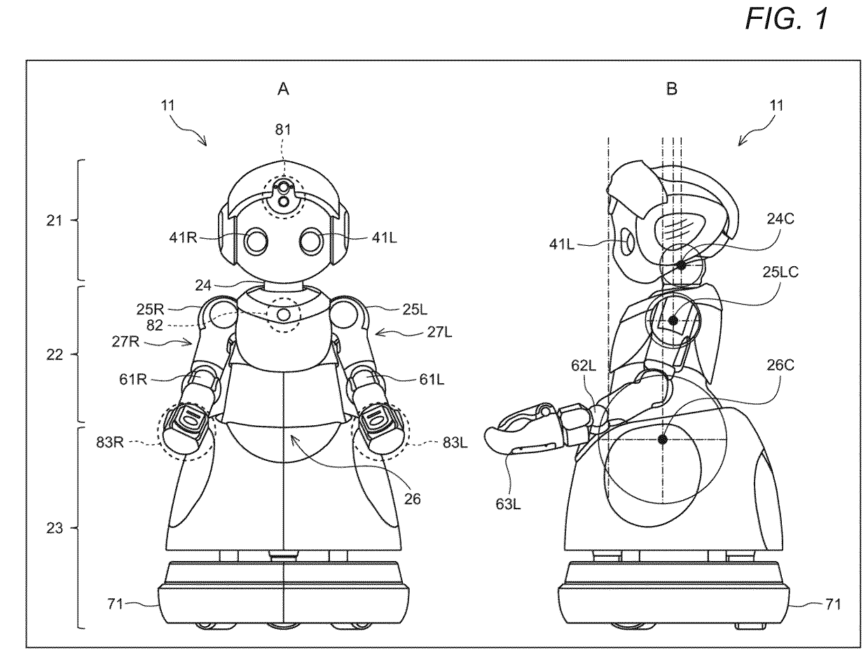

A configuration example of a nursing care robot 11 according to an embodiment of the present technology will be described with reference to FIGS. 1 to 9.

The nursing care robot 11 is a humanoid mobile manipulator robot capable of executing various applications for various types of care, state observation, communication, peripheral tasks, and the like for a target person with highly acceptable quality.

For example, the nursing care robot 11 executes various applications for executing a care action in accordance with a scheduler created on the basis of determination by a care staff and individual setting of robot operation for each target person. Examples of the application that can be executed by the nursing care robot 11 include greeting the target person, relaxing the target person, vital measurement, music therapy, a phone call, and the like. The nursing care robot 11 is configured to be able to execute an application aiming at an effect of preventing an instable state of the target person and adjusting daily rhythm.

### <Configuration Example of Appearance of Nursing Care Robot 11>

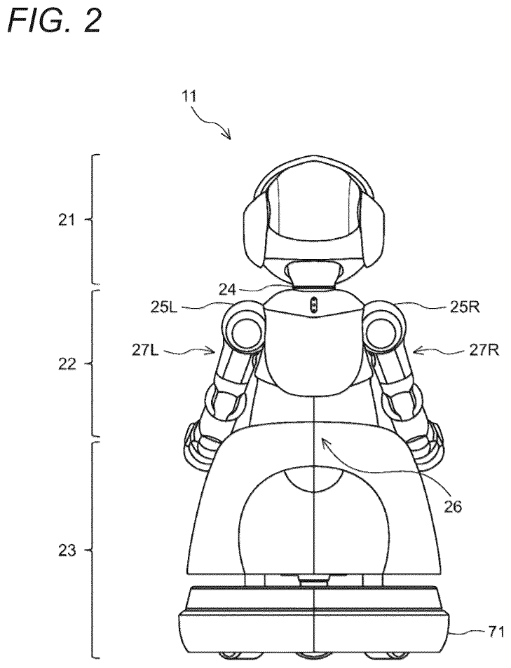

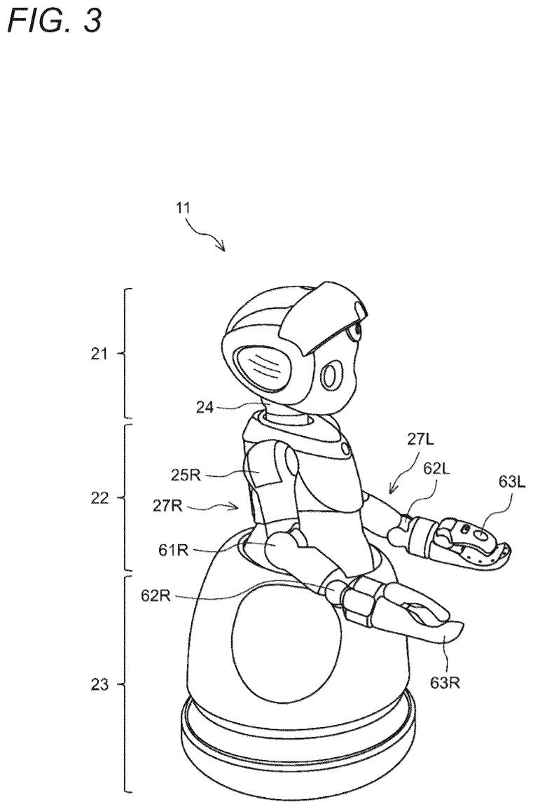

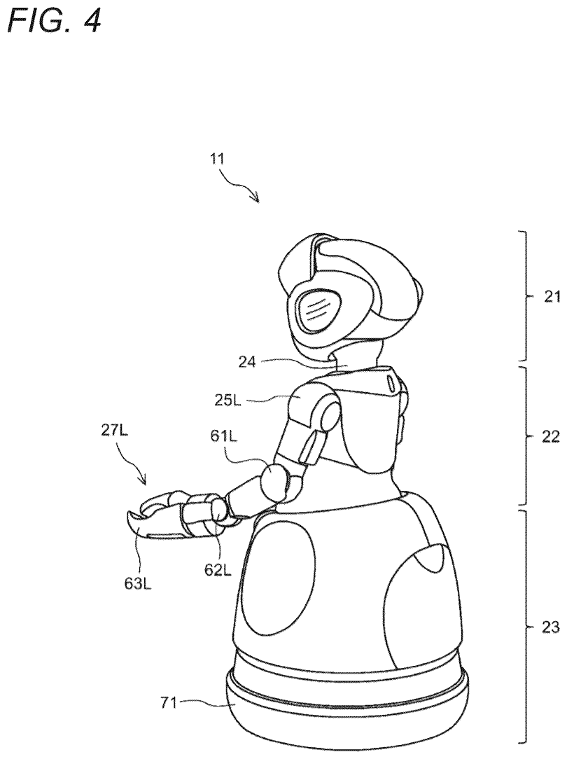

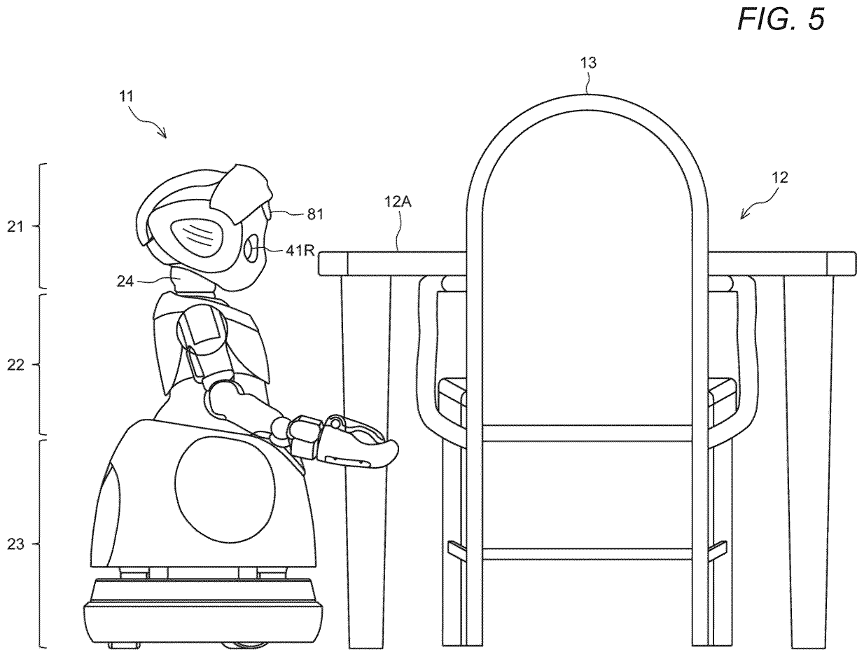

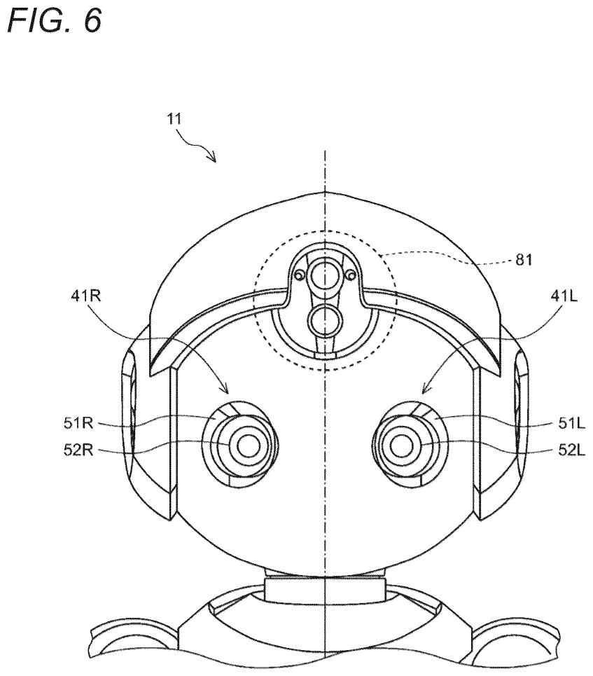

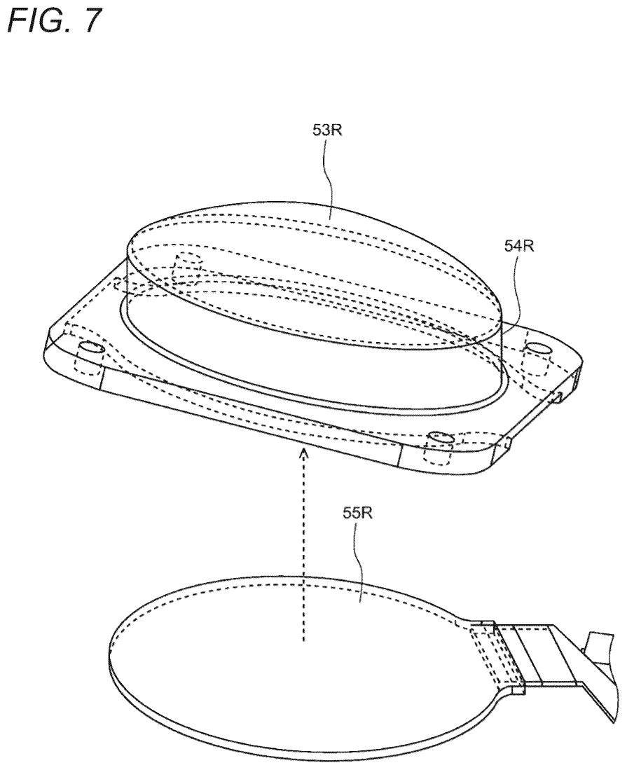

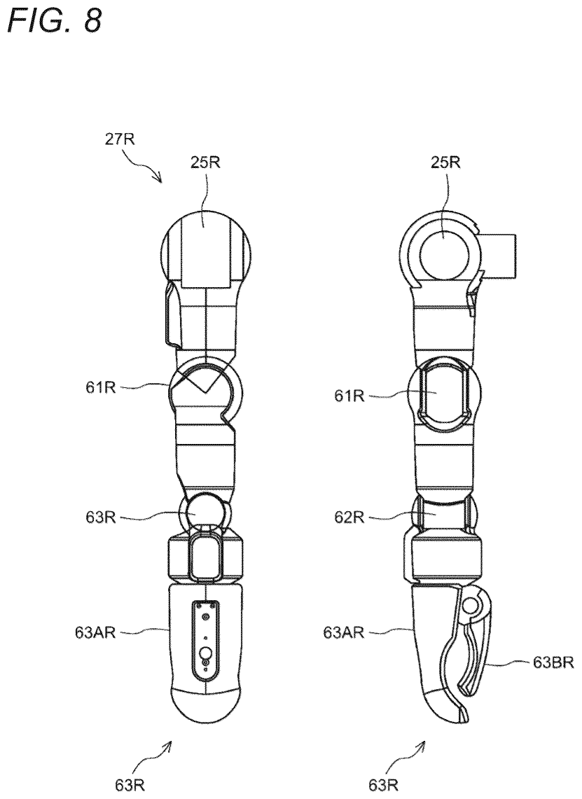

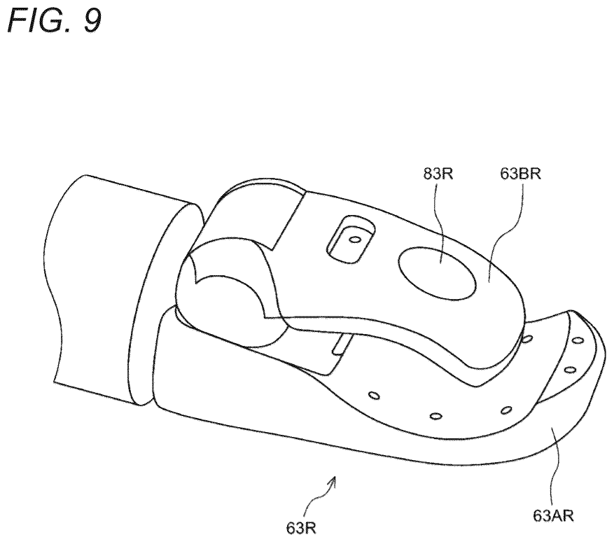

FIGS. 1 to 9 illustrate a configuration example of an appearance of the nursing care robot 11 and the like. A of FIG. 1 is a front view of the nursing care robot 11. B of FIG. 1 is a left side view of the nursing care robot 11. FIG. 2 is a rear view of the nursing care robot 11. FIG. 3 is a perspective view of the nursing care robot 11 as viewed in a diagonally front right direction. FIG. 4 is a perspective view of the nursing care robot 11 as viewed in a diagonally rear left direction. FIG. 5 is a diagram comparing sizes of the nursing care robot 11 and a general table 12. FIG. 6 is an enlarged view of a head portion 21 of the nursing care robot 11. FIG. 7 is an exploded view illustrating an internal configuration example of an eyeball portion 41R of the nursing care robot 11. FIG. 8 is an external view of an arm portion 27R of the nursing care robot 11. FIG. 9 is an external view of a hand 63R of the nursing care robot 11.

The nursing care robot 11 has an appearance modeled on a child, for example, on the basis of a concept of a grandchild robot.

The nursing care robot 11 includes the head portion 21, a chest portion 22, and a base portion 23 that supports the chest portion 22. The base portion 23 includes, for example, a carriage 71 that is movable in all directions and is provided at a lower portion of the base portion 23. As a result, the nursing care robot 11 can move in all directions.

The nursing care robot 11 includes an arm portion 27L attached to an upper-left portion of the chest portion 22, and the arm portion 27R attached to an upper-right portion of the chest portion 22. The nursing care robot 11 includes a movable neck 24 provided between the head portion 21 and the chest portion 22 and including a neck joint shaft 24C. The nursing care robot 11 includes a movable shoulder 25L provided between the chest portion 22 and the arm portion 27L and including a shoulder joint shaft 25LC, and a movable shoulder 25R provided between the chest portion 22 and the arm portion 27R and including a shoulder joint shaft 25RC. In addition, the nursing care robot 11 includes a movable waist 26 provided under the chest portion 22 and including a waist joint shaft 26C.

The height of the nursing care robot 11 is a height at which the target person in a seated position in which the target person is sitting on a chair can slightly look down the nursing care robot 11. In addition, as illustrated in FIG. 5, the height of the nursing care robot 11 is a height at which the general table 12 can be viewed from above.

As illustrated in FIG. 6, the head portion 21 includes an eyeball portion 41L and the eyeball portion 41R. The eyeball portion 41L includes a white portion 51L and a black portion 52L arranged in the white portion 51L. As with the eyeball portion 41L, the eyeball portion 41R includes a white portion 51R and a black portion 52R arranged in the white portion 51R.

As illustrated in FIG. 7, the eyeball portion 41R includes a transparent solid cylindrical portion 54R having a first end surface and a second end surface. The eyeball portion 41R includes a flat eyeball display 55R that is provided on a first end surface side (a lower side in FIG. 7) of the cylindrical portion 54R and that displays a motion of the black portion 52R. The eyeball portion 41 includes a hemispherical transparent spherical portion 53R that is provided on a second end surface side (an upper side in FIG. 7) of the cylindrical portion 54R and that emits display light from the eyeball display 55R incident via the cylindrical portion 54R. The spherical portion 53R is configured as a hemispherical transparent spherical lens. An outer peripheral shape of the spherical portion 53R is configured as the white portion 51R.

An outer peripheral surface of the cylindrical portion 54R is non-transmissive to prevent light from entering, and a display image of the eyeball display 55R viewed through the spherical portion 53R looks clear without distortion. Furthermore, since the spherical portion 53R is arranged in such a way as to be spaced apart from the eyeball display 55R, three-dimensionality for a sense of depth is obtained. Furthermore, the center of the sphere of the spherical portion 53R is designed as a virtual rotation center of the eyeball, and the motion of the black portion 52R displayed on the eyeball display 55R is controlled with reference to the center of the sphere of the spherical portion 53R.

As described above, unlike a flat display, the eyeball portion 42R is displayed on a built-in sphere having good visibility from any angle or appears to be moving, and can replicate the realism of a real eyeball without distortion. In addition, the center of the black portion 52R matches the center of the sphere of the spherical portion 53R, and there is no discomfort in the thickness and shape of the spherical surface. Moreover, reflected light of ambient light is reflected on the surface of the spherical portion 53R, thereby expressing highlight of a pupil naturally and in real-time.

Although not illustrated, the eyeball portion 41L also includes a spherical portion 53L, a cylindrical portion 54L, and an eyeball display 55L, and is configured to be bilaterally symmetrical with the eyeball portion 41R.

For example, the nursing care robot 11 performs human recognition and face recognition using a head Sensor 81, and controls a position of the black portion 52L of the eyeball portion 41L, a position of the black portion 52R of the eyeball portion 41R, and axes (roll, pitch, and yaw) of the neck 24 to gaze at the target person. Specifically, the black portion 52L and the black portion 52R vertically and horizontally follow a position of the target person to gaze at the target person. In addition, a distance to the target person is expressed using a convergence angle (esotropia or exotropia) between the black portion 52L and the black portion 52R. As a result, the target person can easily recognize where a line-of-sight of the nursing care robot 11 is directed (particularly in a depth direction).

Note that, in a case where it is not necessary to individually distinguish the eyeball portion 41L and the eyeball portion 41R, they will be simply referred to as the eyeball portions 41 hereinafter. In a case where it is not necessary to individually distinguish the white portion 51L and the white portion 51R, they will be simply referred to as the white portions 51. In a case where it is not necessary to individually distinguish the black portion 52L and the black portion 52R, they will be simply referred to as the black portions 52. In a case where it is not necessary to individually distinguish the spherical portion 53L and the spherical portion 53R, they will be simply referred to as the spherical portions 53. In a case where it is not necessary to individually distinguish the cylindrical portion 54L and the cylindrical portion 54R, they will be simply referred to as the cylindrical portions 54. In a case where it is not necessary to individually distinguish the eyeball display 55L and the eyeball display 55R, they will be simply referred to as the eyeball displays 55.

As illustrated in FIG. 8, the arm portion 27R includes an elbow portion 61R, a wrist 62R, and the hand 63R. The elbow portion 61R has a pitch axis. The wrist 62R has a yaw axis.

The hand 63R includes a part 63AR corresponding to a portion other than a thumb and a part 63BR corresponding to the thumb. The part 63BR faces the part 63AR and moves to pinch an object with the hand 63R.

Note that, although not illustrated, the arm portion 27L is configured similarly to the arm portion 27R, and includes an elbow portion 61L, a wrist 62L, and a hand 63L. Furthermore, as with the hand 63R, the hand 63L includes a part 63AL and a part 63BL.

In addition, in a case where it is not necessary to individually distinguish the arm portion 27L and the arm portion 27R, they will be simply referred to as the arm portions 27 hereinafter. In a case where it is not necessary to individually distinguish the elbow portion 61L and the elbow portion 61R, they will be simply referred to as the elbow portions 61 hereinafter. In a case where it is not necessary to individually distinguish the wrist 62L and the wrist 62R, they will be simply referred to as the wrist 62 hereinafter. In a case where it is not necessary to individually distinguish the hand 63L and the hand 63R, they will be simply referred to as the hands 63 hereinafter.

The head sensor 81 is provided at an upper-front portion of the head portion 21. The head sensor 81 includes, for example, a distance image sensor, a microphone, a light detection and ranging (LiDAR), and the like.

The head sensor 81 is configured such that a sensing direction substantially coincides with a line-of-sight direction of the nursing care robot 11 to enable execution of a humanitude motion, execution of a face tracking motion, and the like.

For example, the nursing care robot 11 can perform human recognition and face recognition using the head sensor 81, and can perform an interaction in which the pupil of the target person is tracked.

Here, the height of the general table 12 is, for example, about 700 mm, and the height of a general table 12 in a nursing care facility is, for example, about 660 mm. For example, as illustrated in FIG. 5, the head sensor 81 is arranged at a position where a top plate 12A of the table 12 can be viewed from above. The head portion 21 is arranged at a position to look up the face of the target person sitting on a chair 13 (seated position). The head sensor 81 is installed in such a way as to face upward by, for example, about 5 degrees at a high position (for example, a position of about 760 mm in height) of the head portion 21. Furthermore, the head sensor 81 is arranged in such a way as not to protrude too much from an outer diameter line of the head portion 21.

As a result, for example, as illustrated in FIG. 5, the nursing care robot 11 can recognize an object on the standard table 12 and recognize the face of the target person in a seated position across the table 12. The nursing care robot 11 can recognize the face of the target person in a seated position on a standard bed or the face of the target person in a supine position on the standard bed. The nursing care robot 11 can perform face recognition at an angle for looking up the close target person in a seated position, face recognition at an angle for looking up the close target person in a standing position, and the like.

A chest sensor 82 is provided at an upper-front portion of the chest portion 22. The chest sensor 82 includes, for example, a non-contact vital sensor or the like. Examples of the non-contact vital sensor include a body temperature sensor, a heart rate sensor, and a respiration sensor.

The chest sensor 82 is installed in such a way as to face upward by, for example, about 10 degrees at a position (for example, a position of a height of about 537 mm) at the upper-front portion of the chest portion 22. As a result, the chest sensor 82 can perform measurement without being affected by the motion of the head portion 21. The chest sensor 82 can reduce occurrence of a blind spot due to the arm portion 27 during manipulation. The chest sensor 82 can perform vital sensing from the face of the target person in a seated position, the face of the distant target person (for example, about 2 m) in a standing position, the face of the close target person in a supine position, and the like. The chest sensor 82 can constantly sense a change in a state of the target person during execution of an application.

A hand sensor 83R is provided in the hand 63R. The hand sensor 83R includes, for example, a contact vital sensor or the like. Examples of the contact vital sensor include a heart rate sensor, a blood pressure sensor, and an oxygen saturation measurement sensor.

For example, as illustrated in FIG. 9, the hand sensor 83R is arranged on an outer side of the part 63BR of the hand 63R. As a result, the hand 63R is prevented from pinching the hand of the target person at a time of vital sensing.

In addition, vital sensing can be performed in a manner in which the target person places his/her hand on or holds the hand sensor 83R, not the nursing care robot 11 actively touching the target person with the hand Sensor 83R. This is an interface familiar to persons with dementia, and acceptability for the target person is high. In addition, a sensor or the like for gripping force control can be separately provided inside the hand 63R.

Note that, although not illustrated, a hand sensor 83L including a vital sensor similar to that of the hand sensor 83R is provided on an outer side of the part 63BL of the hand 63L.

### «2. Modifications»

Modifications of the above-described embodiment of the present technology will be described hereinafter.

<Modifications of Hand (Robot Hand Mechanism) of Nursing Care Robot 11>

First, modifications of a robot hand mechanism, which is the hand of the nursing care robot 11, will be described.

Note that, although modifications of the right hand of the nursing care robot 11 will be described hereinafter, it is assumed that the left hand also has a similar bilaterally symmetrical configuration.

### <First Modification of Hand>

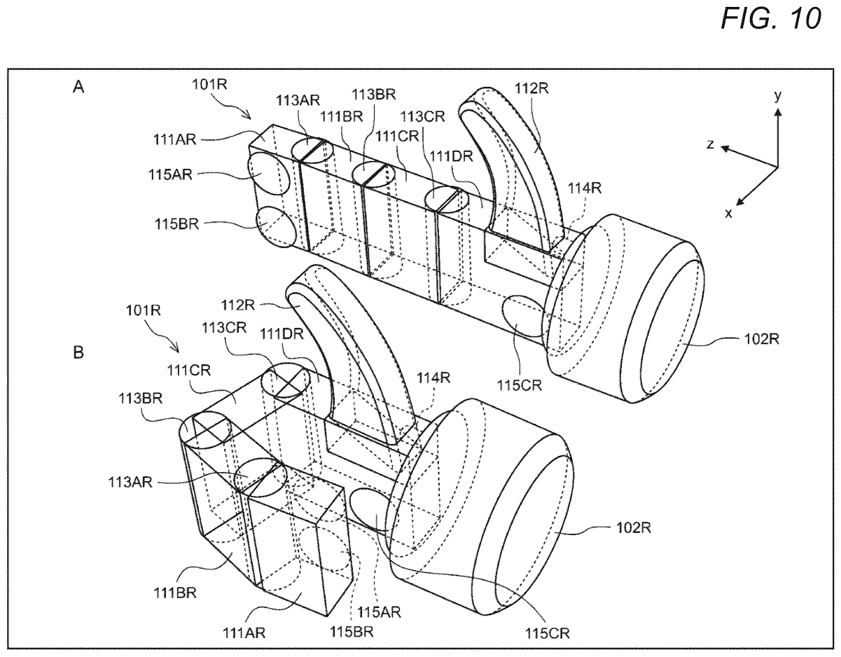

First, a first modification of the hand of the nursing care robot 11 will be described with reference to FIGS. 10 to 12.

FIGS. 10 to 12 schematically illustrate a configuration example of an appearance of a hand 101R corresponding to the right hand of the nursing care robot 11. In FIGS. 10 to 12, a part of the hand 101R is shown as transparent, and the transparent part is indicated by dotted lines. This also applies to the following drawings.

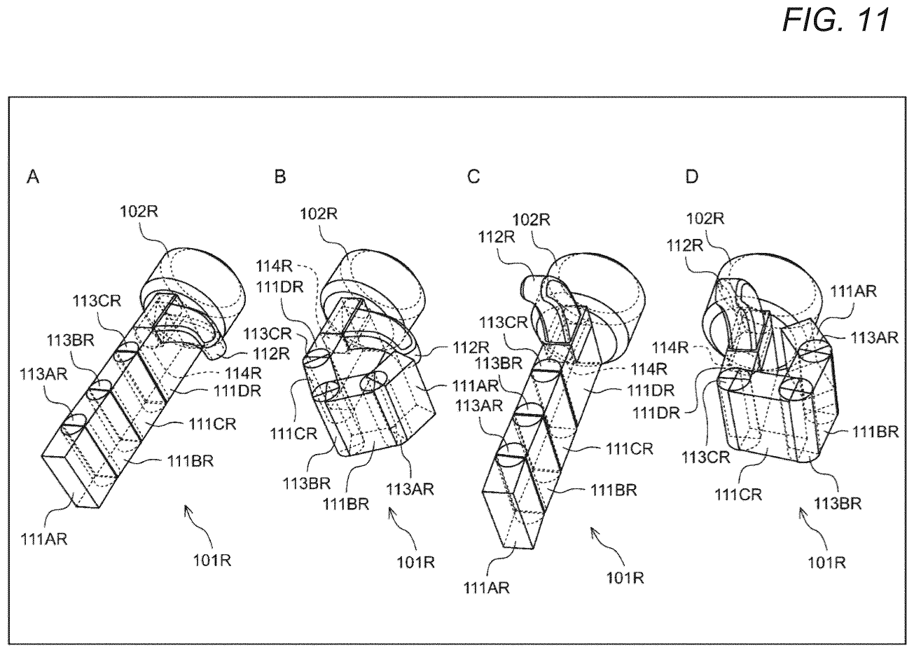

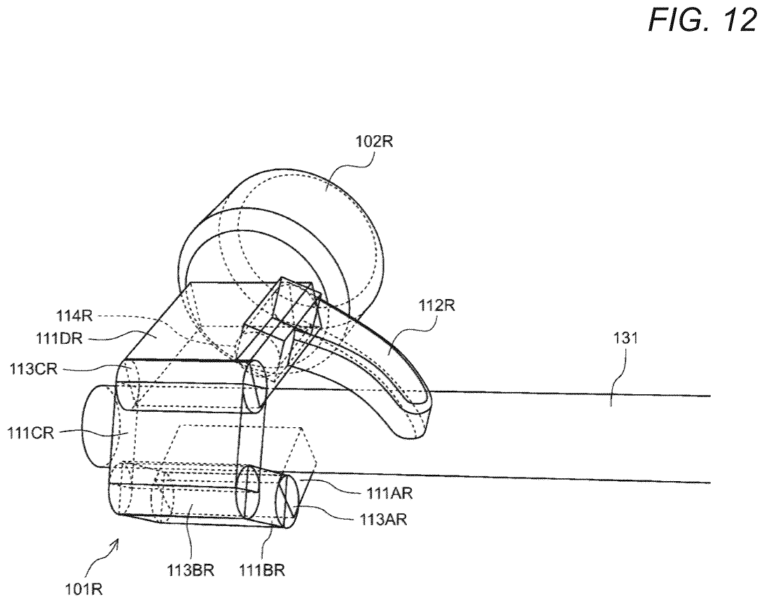

A of FIG. 10 illustrates a state in which the hand 101R is open. B of FIG. 10 illustrates a state in which a portion corresponding to the thumb of the hand 101R is open and a portion corresponding to a finger other than the thumb is closed. A of FIG. 11 illustrates a state in which a portion corresponding to a portion (hereinafter referred to as a main portion) other than the thumb of the hand 101R is open and the portion corresponding to the thumb is closed. B of FIG. 11 illustrates a state in which a portion corresponding to the fingers of the hand 101R are closed, that is, a state in which the hand 101R is clenched into a fist. C of FIG. 11 illustrates a state in which the hand 101R is open as in A of FIG. 10. D of FIG. 11 illustrates a state in which the portion corresponding to the thumb of the hand 101R is open and the portion corresponding to the fingers other than the thumb is closed as in B of FIG. 10. FIG. 12 illustrates a state in which the hand 101R grasps a rod-shaped bar 131.

In the following description, a coordinate system is defined as illustrated in FIG. 10. A thickness direction of the hand 101R is defined as an x-axis direction, and a direction from the back of the hand toward the palm is defined as a positive direction. A width direction of the hand 101R is defined as a y-axis direction, and a direction from the little finger toward the thumb is defined as a positive direction. A longitudinal direction of the hand 101R (a direction in which the hand 101R extends) is defined as a z-axis direction, and a direction from the wrist toward the fingertip is defined as a positive direction. An x-axis, a y-axis, and a z-axis are orthogonal to each other.

In the following description, a rotation direction around a rotation axis (roll axis) parallel to the x-axis is defined as a roll direction. A rotation direction around a rotation axis (pitch axis) parallel to the y-axis is defined as a pitch direction. A rotation direction around a rotation axis (yaw axis) parallel to the z-axis is defined as a yaw direction. The roll direction, the pitch direction, and the yaw direction are orthogonal to each other.

This coordinate system also applies to the following modifications of the nursing care robot 11.

A base of the hand 101R is supported by a cylindrical part 102R. The hand 101R includes parts 111AR to 111DR corresponding to the main portion other than the thumb, a part 112R corresponding to the thumb, actuators 113AR to 113CR, an actuator 114R, and tactile Sensors 115AR to 115CR.

Note that the tactile sensors 115AR to 115CR are not illustrated in FIGS. 11 and 12.

The part 111AR is a rectangular plate-shaped member corresponding to distal sections of the index to little fingers.

The part 111BR is a rectangular plate-shaped member corresponding to middle sections of the index to little fingers.

The part 111CR is a rectangular plate-shaped member corresponding to proximal sections of the index to little fingers.

The part 111DR is a rectangular plate-shaped member corresponding to the palm and the back of the hand.

The part 112R has a shape in which a thumb portion having a thumb shape is connected to a side surface of a cylindrical rotation shaft. The rotation shaft of the part 112R is arranged in the part 111DR in such a way as to extend in the x-axis direction near a base and an end portion of the part 111DR in the y-axis direction. A diameter of the rotation shaft of the part 112R and a thickness of the thumb portion are substantially the same as a thickness of the part 111DR.

Note that the shape of the thumb portion is not limited to this example. For example, the thumb portion may have a frame shape having an angle of 45 degrees to 90 degrees with respect to the Z-axis. In addition, a cross section of the thumb portion may have a shape suitable for gripping an object or may have a circular shape (that is, the thumb portion has a cylindrical shape).

The parts 111AR to 111DR are connected in such a way as to be arranged side-by-side in the z-axis direction via the actuators 113AR to 113CR in a state where the hand 101R is open. Therefore, the main portion of the hand 101R has a plate shape in a state where the hand 101R is open.

The actuator 113AR corresponds to distal inter phalangeal (DIP) joints of the index to little fingers, connects the parts 111AR and 111BR to each other, and forms the pitch axis extending in the y-axis direction.

The actuator 113AR rotates the part 111AR in the pitch direction with respect to the part 111BR to move the part 111AR closer to the part 111BR or away from the part 111BR. As a result, a portion of the hand 101R corresponding to the DIP joints of the index to little fingers can be flexed and extended in the pitch direction.

The actuator 113BR corresponds to proximal inter phalangeal (PIP) joints of the index to little fingers, connects the parts 111BR and 111CR to each other, and forms the pitch axis extending in the y-axis direction.

The actuator 113BR rotates the part 111BR in the pitch direction with respect to the part 111CR to move the part 111BR closer to the part 111CR or away from the part 111CR. As a result, a portion of the hand 101R corresponding to the PIP joints of the index to little fingers can be flexed and extended in the pitch direction.

The actuator 113CR corresponds to metacarpophalangeal (MP) joints of the index finger the little finger, connects the parts 111CR and 111DR to each other, and forms the pitch axis extending in the y-axis direction. The actuator 113CR rotates the part 111CR in the pitch direction with respect to the part 111DR to move the part 111CR closer to the part 111DR or away from the part 111DR. As a result, a portion of the hand 101R corresponding to the MP joints of the index to little fingers can be flexed and extended in the pitch direction.

The actuator 114R corresponds to an MP joint of the thumb, connects the parts 111DR and 112 to each other, and forms the yaw axis extending in the z-axis direction. The actuator 114R is arranged in the rotation shaft of the part 112R. Since the rotation shaft of the part 112R is arranged in the part 111DR, the actuator 114R is also arranged in the part 111DR. The actuator 114R rotates the part 112R in the yaw direction with respect to the part 111DR to move the thumb portion of the part 112R closer to the part 111DR or away from the part 111DR. As a result, a portion of the hand 101R corresponding to the MP joint of the thumb can be rotated in the yaw direction.

Note that the rotation shaft of the part 112R need not necessarily be parallel to the z-axis, and may be inclined in an oblique direction around the x-axis (around the roll axis) with respect to the z-axis. Specifically, for example, an orientation of the rotation shaft of the part 112R may be within a range of ±45 degrees (−45 degrees to +45 degrees) around the x-axis with respect to the z-axis.

The tactile sensors 115AR and 115BR are provided near both ends of a palm-side tip of the part 111AR in the width direction. The tactile sensor 115CR is provided near a palm-side base of the part 111DR and an end portion of the part 111DR away from the part 112R. As a result, contact with a palm side of the hand 101R is detected.

Note that the shape, position, and number of tactile sensors in FIG. 10 are examples, and may be appropriately changed. For example, a tactile sensor may be provided on the part 112R. Furthermore, for example, one or more of a force sensor, a proximity sensor, an image sensor, a contact switch, and the like may be used instead of, or together with, the tactile sensor.

The actuators 113AR to 113CR and the actuator 114R are housed in the main portion of the hand 101R including the parts 111AR to 111DR. Then, as illustrated in A of FIG. 10, in a state where the hand 101R is open (a state where the main portion and the thumb portion are extended), the actuators 113AR to 113CR and the actuator 114R are arranged on the same plane. In addition, the parts 111AR to 111DR and the part 112 form flat surfaces on both surfaces (the palm side and a back side of the hand) of the hand 101R.

As described above, since the flat surface is formed on the palm side of the hand 101R in a state where the hand 101R is open, an interaction of the nursing care robot 11 with the target person becomes smooth. For example, since there is no obstacle in a case where the target person grasps the hand 101R, a natural handshake is possible. For example, since the flat surface is formed, a contact area can be maximized at a time of contact with the target person, and accordingly a pressure is dispersed and it is possible to suppress the target person from feeling pain. For example, the nursing care robot 11 can open the hand 101R and rub, support, or pat the shoulder, back, hand, arm, or the like of the target person. In nursing care settings, target persons often require contact and handshakes. With this respect, since the nursing care robot 11 can naturally touch the target person with the hand 101R or the target person can naturally touch the hand 101R, the acceptability for the target person improves, and an interaction with the target person becomes smooth.

In addition, since the flat surfaces are formed, a degree of freedom of arrangement of sensors increases, and the sensors can be arranged at more appropriate positions. As a result, measurement accuracy of the sensors improves, and an interaction in which a contact force or the like is controlled is more appropriately executed.

In addition, a gripping function of the hand 101R is achieved. For example, by bending each joint of the hand 101R, it is possible to grasp, hold, or support an object such as a hand of a person. For example, an object can be gripped in parallel by a palm-side surface of the part 111AR and a palm-side surface of the part 111DR. For example, a tip of the part 111AR and a tip of the part 112R can come into contact with each other, and an object can be held (gripped in parallel) by the tip of the part 111AR and the tip of the part 112R. For example, as illustrated in FIG. 12, the hand 101R can firmly grasp the bar 131 with the parts 111AR to 111DR and the part 112R.

Note that, although the following description is not illustrated, for example, the hand 101R can perform parallel track gripping on the same plane. Specifically, for example, in a case of picking up a coin on a desk, the hand 101R can grip the coin by bringing a tip of the thumb portion of the part 112R and a tip of the main portion of the hand 101R close to (substantially into contact with) the desk and moving the tip of the main portion of the hand 101R along a trajectory parallel to a gripping surface of the thumb portion of the part 112R in a state where a position and a posture of the arm portion 27R are fixed. This can be achieved because the main portion of the hand 101R has three pitch axes, and controllability is favorable.

For example, the hand 101R may have a gripping mode of precision grasp for two representative surfaces of an object that are not parallel to each other but form an angle (for example, a tapered object, a triangular prism-shaped object, etc.).

For example, the hand 101R may have a gripping mode of precision grasp and power grasp for a spherical object, a cylindrical object, and a quadrangular prism-shaped object.

For example, the hand 101R may have a gripping mode of power grasp on the palm side of the main portion of the hand 101R while supporting, with the thumb portion of the part 112R, a moment load of an object (for example, a door handle, a frying pan, etc.) having a shape that causes the moment load.

As described above, the hand 101R can facilitate an interaction between the nursing care robot 11 and the target person without impairing the gripping function.

### <Second Modification of Hand>

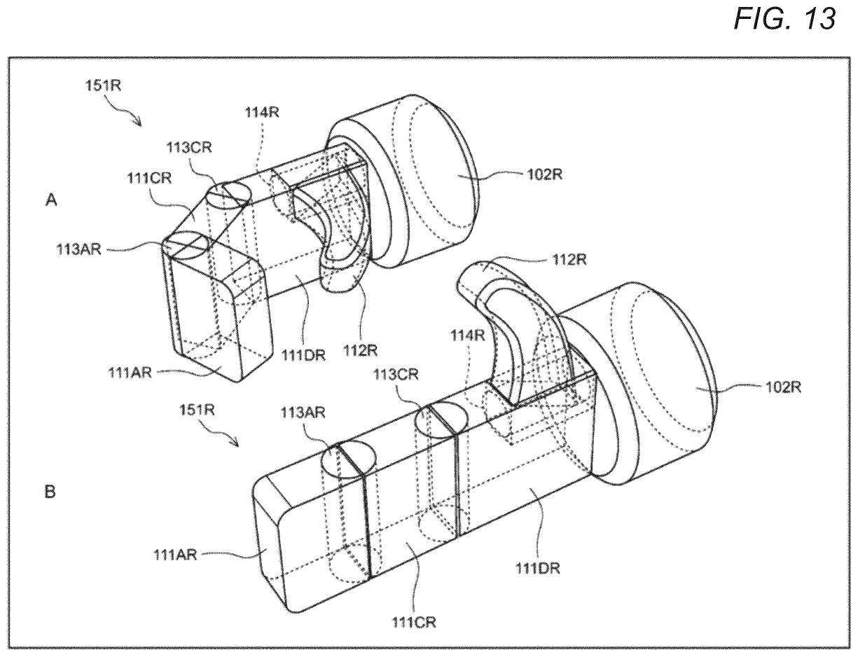

Next, a second modification of the hand of the nursing care robot 11 will be described with reference to FIG. 13.

FIG. 13 schematically illustrates a configuration example of an appearance of a hand 151R corresponding to the right hand of the nursing care robot 11. A of FIG. 13 illustrates a state in which the hand 151R is clenched into a fist. B of FIG. 13 illustrates a state in which the hand 151R is open. Note that, in the drawing, portions corresponding to those of the hand 101R in FIGS. 10 to 12 are given the same reference numerals, and description thereof is omitted as appropriate.

The hand 151R is different from the hand 101R in that the part 111BR and the actuator 113BR are removed. That is, the hand 151R is different from the hand 101R in that portions corresponding to the middle sections of the index to little fingers and the PIP joints of the index to little fingers are removed, and the number of pitch axes for flexing and extending the portions corresponding to the index to little fingers is reduced from three to two.

In the hand 151R, as in the hand 101R, flat surfaces are formed on both surfaces (a palm side and a back side of the hand) of the hand 151R in an open state. Therefore, as with the hand 101R, the hand 151R can facilitate an interaction between the nursing care robot 11 and the target person.

Furthermore, like the hand 101R, it is difficult for the hand 151R to grip an object in parallel with a palm-side surface of a part 111AR and a palm-side surface of a part 111DR, but the hand 151R can freely grip an object.

### <Third Modification of Hand>

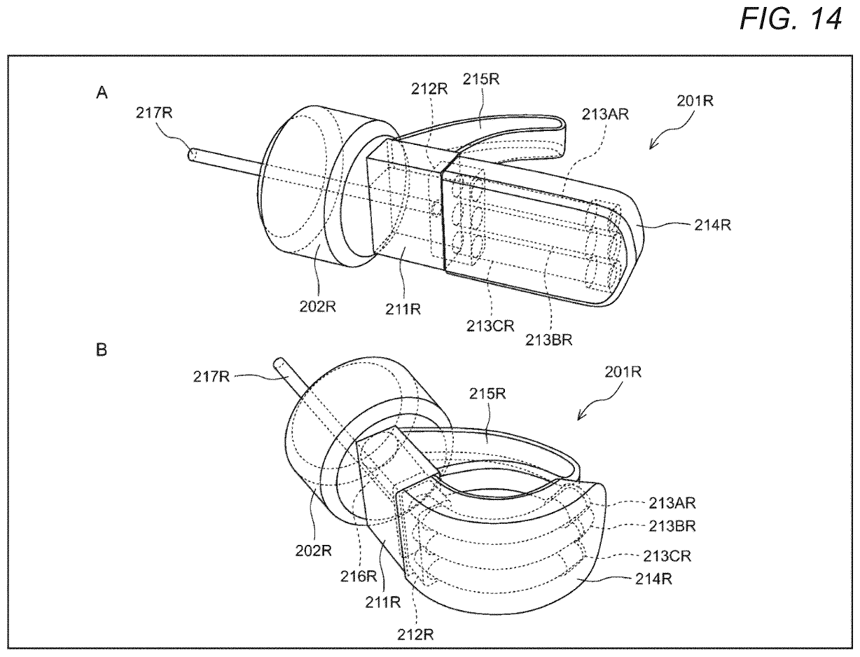

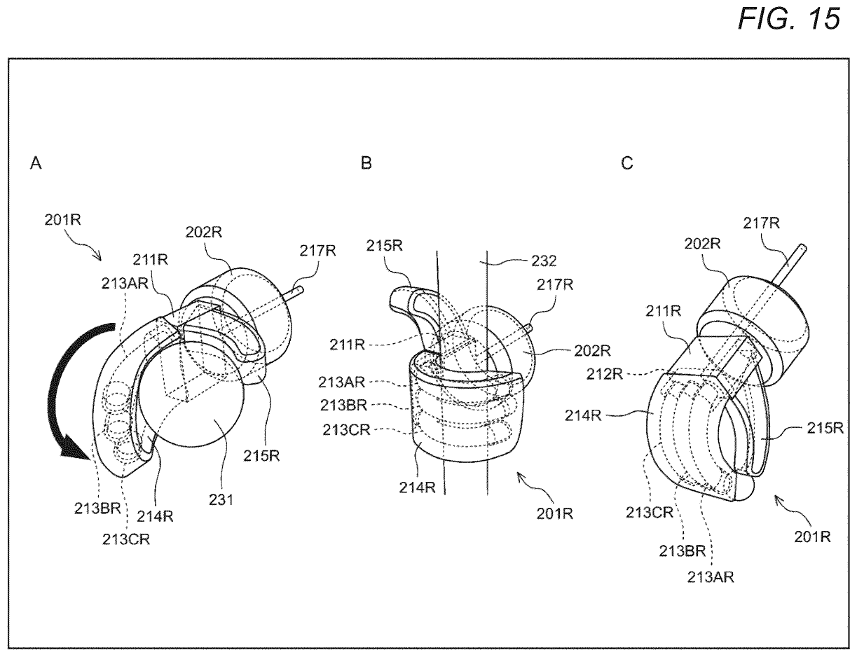

Next, a third modification of the hand of the nursing care robot 11 will be described with reference to FIGS. 14 and 15.

FIGS. 14 and 15 schematically illustrate a configuration example of an appearance of a hand 201R corresponding to the right hand of the nursing care robot 11.

A of FIG. 14 illustrates a state in which a portion of the hand 201R corresponding to the portion (hereinafter, referred to as a main portion) other than the thumb is extended and the portion corresponding to the thumb is flexed. B of FIG. 14 illustrates a state in which the portion corresponding to the fingers of the hand 201R are flexed, that is, a state in which the hand 201R is clenched into a fist. A of FIG. 15 illustrates a state in which the hand 201R grips a ball 231. B of FIG. 15 illustrates a state in which the hand 201R grips a rod-shaped bar 232. C of FIG. 15 illustrates a state in which the hand 201R holds a small object.

A base of the hand 201R is supported by a cylindrical part 202R. The hand 201R includes a part 211R, a pneumatic branching unit 212R, pneumatic bending actuators 213AR to 213CR, an exterior 214R, a part 215R, an actuator 216R, and a tube 217R. The part 211R, the pneumatic branching unit 212R, the pneumatic bending actuators 213AR to 213CR, and the exterior 214R correspond to the main portion of the hand. The part 215R corresponds to the thumb and has a shape similar to that of the part 112R of the hand 101R.

In a case where it is not necessary to individually distinguish the pneumatic bending actuators 213AR to 213CR, they will be simply referred to as the pneumatic bending actuators 213R hereinafter.

Note that the actuator 216R is not illustrated in A of FIG. 14 and FIG. 15.

The part 211R is a rectangular plate-shaped member corresponding to the palm and the back of the hand as with the part 111DR of the hand 101R.

A distal end side of the pneumatic branching unit 212R is inserted into the part 211R, and a tip side of the pneumatic branching unit 212R protrudes from the part 211R.

Each pneumatic bending actuator 213R is a cylindrical member having the same diameter. The pneumatic bending actuators 213R are connected to a tip of the pneumatic branching unit 212R at distal ends thereof, extend in the z-axis direction, and are arranged side-by-side in the y-axis direction.

Each pneumatic bending actuator 213R is covered with the exterior 214R. A flexible and waterproof material such as urethane rubber is used for the exterior 214R.

A rotation shaft of the part 215R is arranged in the part 211R in such a way as to extend in the x-axis direction at an end portion of the part 211R in the width direction. A diameter of the rotation shaft of the part 215R and a thickness of a thumb portion are substantially the same as a thickness of the part 211R.

The actuator 216R corresponds to the MP joint of the thumb, connects the parts 211R and 215R to each other, and forms a yaw axis extending in the z-axis direction. The actuator 216R is arranged in the rotation shaft of the part 215R. Since the rotation shaft of the part 215R is arranged in the part 211R, the actuator 216R is also arranged in the part 211R. The actuator 216R rotates the part 215R in the yaw direction with respect to the part 211R, and moves the thumb portion of the part 215R close to the part 211R and away from the part 211R. As a result, a portion of the hand 201R corresponding to the MP joint of the thumb can be rotated in the yaw direction.

Note that the rotation shaft of the part 215R need not necessarily be parallel to the z-axis, and may be inclined in an oblique direction about the x-axis (about the roll axis) with respect to the z-axis. Specifically, for example, an orientation of the rotation shaft of the part 215R only needs to be within a range of ±45 degrees about the x-axis with respect to the z-axis.

The tube 217R penetrates through the part 202R, and has one end connected to the distal end of the pneumatic branching unit 212R and another end connected to a pneumatic source (not illustrated).

In a case where the pneumatic source discharges air, the discharged air is inserted into each pneumatic bending actuator 213R via the tube 217R and the pneumatic branching unit 212R. As a result, air pressure in each pneumatic bending actuator 213R increases.

In a case where the pneumatic source sucks air, on the other hand, air in each pneumatic bending actuator 213R is discharged via the pneumatic branching unit 212R and the tube 217R. As a result, the air pressure in each pneumatic bending actuator 213R decreases.

As described above, by changing the air pressure in each pneumatic bending actuator 213R, each pneumatic bending actuator 213R and the exterior 214R can be extended as illustrated in A of FIG. 14 or flexed in the pitch direction as illustrated in B of FIG. 14. That is, a portion of the hand 201R corresponding to the index to little fingers can be flexed and extended in the pitch direction.

Furthermore, as described above, the thumb portion of the part 215R can be rotated in the yaw direction.

As a result, as with the hand 101R, the hand 201R can be opened and clenched into a fist.

For example, although not illustrated, flat surfaces are formed on both surfaces (the palm side and the back side of the hand) of the hand 201R by opening the hand 201R. As a result, as with the hand 101R, the hand 201R can facilitate an interaction between the nursing care robot 11 and the target person.

Furthermore, as with the hand 101R, the hand 201R can grasp, hold, and support an object such as a hand of a person.

For example, as illustrated in A of FIG. 15, the hand 201R can grip a sphere such as the ball 231 or an object (for example, a cup or a bowl having a tapered shape, etc.) having a curved surface in such a way as to cover the sphere or the object. Furthermore, for example, also in a case where the nursing care target person shakes hands, the shape of the hand 201R can be matched with a shape of the hand of the target person.

For example, as illustrated in B of FIG. 15, the hand 201R can firmly hold the bar 222 or a handle (for example, a door handle, a bucket handle, etc.).

For example, as illustrated in C of FIG. 15, in the hand 201R, a tip of the exterior 214R and a tip of the part 215R can come into contact with each other, and a small object can be held (gripped in parallel) by the tip of the exterior 214R and the tip of the part 215R.

As described above, the shape of the hand 201R can conform to an object to be gripped by adjusting the air pressure in each pneumatic bending actuator 213R and a bending angle of the pneumatic bending actuator 213R in accordance with a shape of the object. As a result, stability of gripping of an object by the hand 201R improves.

In addition, gripping force and rigidity of the hand 201R can be enhanced by arranging the plurality of pneumatic bending actuators 213R in the y-axis (pitch axis) direction and bending the plurality of pneumatic bending actuators 213R in the pitch direction. Moreover, the gripping force and rigidity of the hand 201R can be further enhanced by preventing deformation of each pneumatic bending actuator 213R in the roll direction using the exterior 214R. Furthermore, gaps between the pneumatic bending actuators 213R are closed by the exterior 214R, and the hand 201R can be brought into surface contact with an object.

Moreover, since the plurality of pneumatic bending actuators 213R shares one pneumatic source, the hand 201R can be downsized. Moreover, by simultaneously driving the plurality of pneumatic bending actuators 213R with one pneumatic source, responsiveness for closing and opening the hand 201R in the pitch direction is improved.

In addition, the exterior 214R improves waterproofness, flexibility, robustness, and hygiene of the hand 201R. For example, each pneumatic bending actuator 213R hardly interferes with an environment or an object. In addition, even in a case where the hand 201R roughly comes into contact with an environment, a person, or an object, the hand and the environment, the person, or the object are prevented from being damaged. Moreover, deterioration of members inside the hand 201R can be suppressed.

Note that a range covered by the exterior 214R can be expanded.

Moreover, by using the pneumatic bending actuator 213R, cost reduction and weight reduction can be achieved, and heat generation during operation of the hand 201R is prevented.

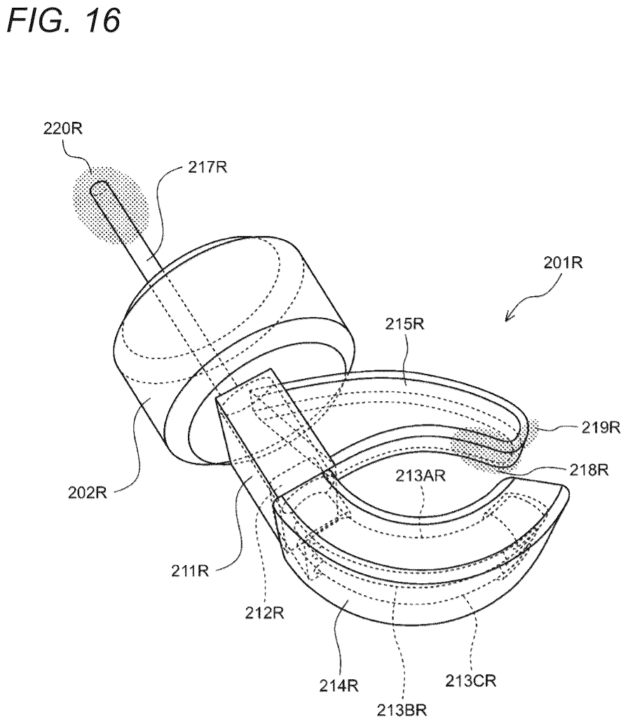

Note that, for example, as illustrated in FIG. 16, a distance sensor 218R and a distance sensor 219R may be provided at a tip of the thumb portion of the part 215R. Furthermore, for example, the pneumatic source may be provided with a pneumatic sensor 220R. Note that a tactile sensor may be provided instead of, or together with, the distance sensor 218R and the distance sensor 219R.

### <Fourth Modification of Hand>

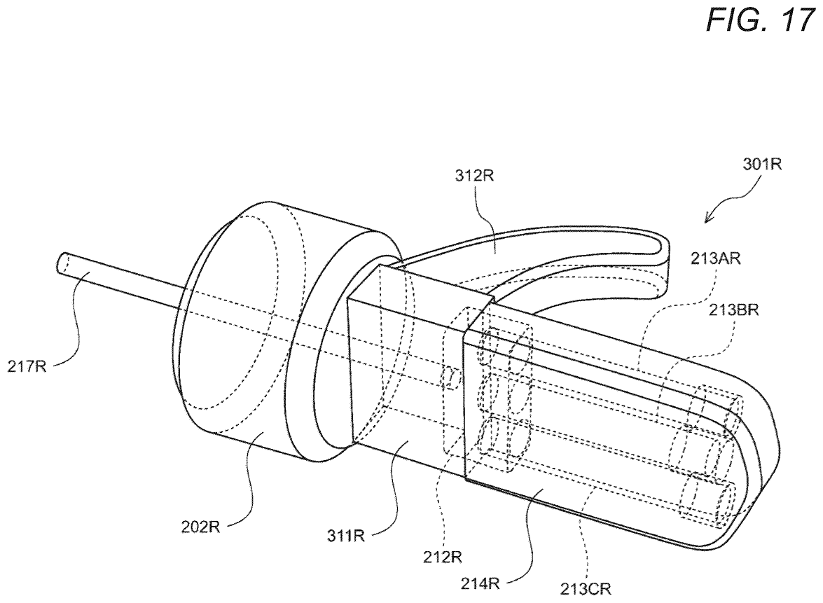

Next, a fourth modification of the hand of the nursing care robot 11 will be described with reference to FIG. 17.

FIG. 17 schematically illustrates a configuration example of an appearance of a hand 301R corresponding to the right hand of the nursing care robot 11. Note that, in the drawing, portions corresponding to those of the hand 201R in FIGS. 14 and 15 are given the same reference numerals, and description thereof is omitted as appropriate.

The hand 301R is different from the hand 201R in that a part 311R and a part 312R are provided instead of the part 211R and the part 215R, and the actuator 216R is removed.

The parts 311R and 312R have shapes substantially similar to those of the parts 211R and 215R of the hand 201R. The part 312R, however, is fixed to the part 311R in such a way as not to move. That is, a thumb portion of the part 312R is fixed in a direction perpendicular to the palm of the hand 301R.

### <Fifth Modification of Hand>

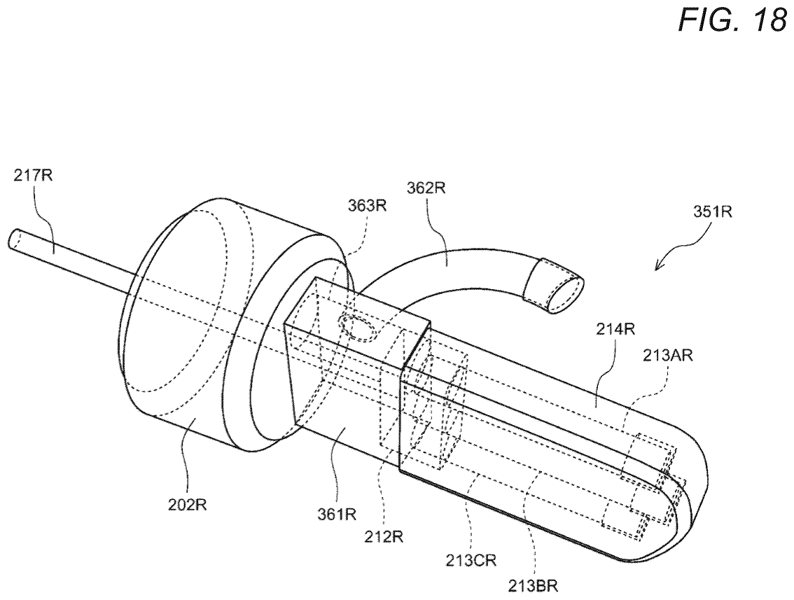

Next, a fifth modification of the hand of the nursing care robot 11 will be described with reference to FIG. 18.

FIG. 18 schematically illustrates a configuration example of an appearance of a hand 351R corresponding to the right hand of the nursing care robot 11. Note that, in the drawing, portions corresponding to those of the hand 301R in FIG. 17 are given the same reference numerals, and description thereof is omitted as appropriate.

The hand 351R is different from the hand 301R in that a part 361 and a pneumatic bending actuator 362R are provided instead of the part 311R and the part 312R, and an actuator 363R is added.

The part 361R has a shape substantially similar to that of the part 311R of the hand 301R.

The pneumatic bending actuator 362R is a member corresponding to the thumb. The pneumatic bending actuator 362R may be in either the roll direction or the pitch direction.

The actuator 363R corresponds to the MP joint of the thumb, is arranged in the part 361R, connects the part 361R and the pneumatic bending actuator 362R to each other, and forms the yaw axis extending in the z-axis direction. The actuator 363R rotates the pneumatic bending actuator 362R in the yaw direction with respect to the part 361R to move the pneumatic bending actuator 362R closer to the part 361R or away from the part 361R. As a result, a portion of the hand 351R corresponding to the MP joint of the thumb can be rotated in the yaw direction.

Note that a rotation shaft of the pneumatic bending actuator 362R need not necessarily be parallel to the z-axis, and may be inclined in an oblique direction about the x-axis (about the roll axis) with respect to the z-axis. Specifically, for example, an orientation of the rotation shaft of the pneumatic bending actuator 362R may be within a range of ±45 degrees about the x-axis with respect to the z-axis.

Note that the pneumatic bending actuator 362R may be covered with an exterior. In this case, the exterior covering each pneumatic bending actuator 213R and the pneumatic bending actuator 362R may be common.

### <Sixth Modification of Hand>

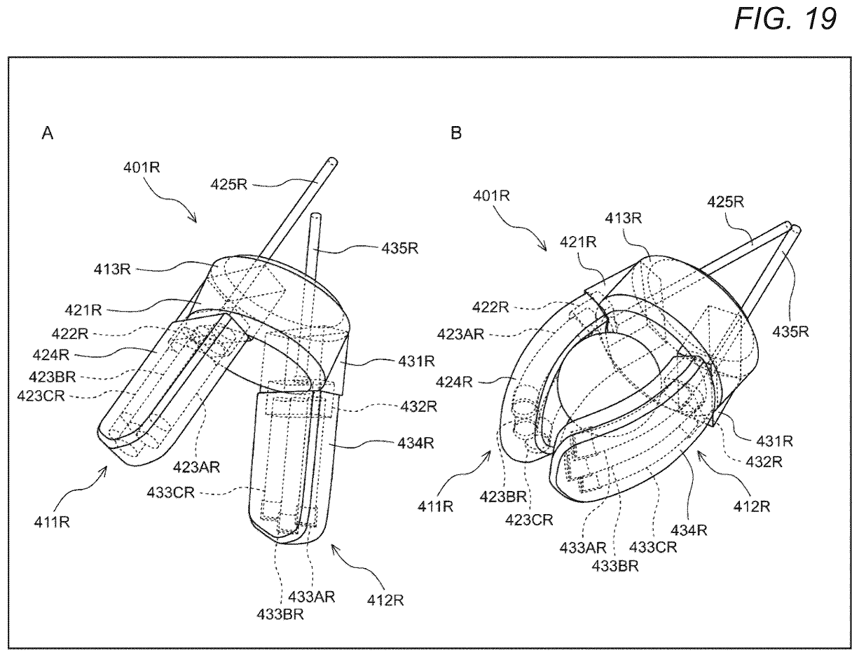

Next, a sixth modification of the hand of the nursing care robot 11 will be described with reference to FIG. 19.

FIG. 19 schematically illustrates a configuration example of an appearance of a hand 401R corresponding to the right hand of the nursing care robot 11. A of Fig. 19 illustrates a state in which the hand 401R is open. B of FIG. 19 illustrates a state in which the hand 401R holds a ball 402.

The hand 401R includes a gripper 411R, a gripper 412R, and a part 413R. The gripper 411R and the gripper 412R have bases fixed by the cylindrical part 413R, and face each other.

The gripper 411R includes a part 421R, a pneumatic branching unit 422R, pneumatic bending actuators 423AR to 423CR, an exterior 424R, and a tube 425R.

The gripper 412R includes a part 431R, a pneumatic branching unit 432R, pneumatic bending actuators 433AR to 433CR, an exterior 434R, and a tube 435R.

The gripper 411R and the gripper 412R have a configuration similar to that of a portion including the part 211R of the hand 201R, the pneumatic branching unit 212R, the pneumatic bending actuators 213AR to 213CR, the exterior 214R, and the tube 217R in FIGS. 14 and 15.

Note that the tube 425R of the gripper 411R and the tube 435R of the gripper 412R are connected to different pneumatic sources.

In a case where it is not necessary to individually distinguish the pneumatic bending actuators 423AR to 423CR, they will be simply referred to as the pneumatic bending actuators 423R hereinafter. In a case where it is not necessary to individually distinguish the pneumatic bending actuators 433AR to 433CR, they will be simply referred to as the pneumatic bending actuators 433R hereinafter.

The gripper 411R and the gripper 412R face each other and can be bent in a direction in which the gripper 411R and the gripper 412R face each other. That is, each pneumatic bending actuator 423R and the exterior 424R of the gripper 411R can be flexed and extended in the pitch direction, and can be flexed in a direction toward the gripper 412R. Each pneumatic bending actuator 433R and the exterior 434R of the gripper 412R can be flexed and extended in the pitch direction and can be flexed in a direction toward the gripper 411R.

As a result, for example, as illustrated in B of FIG. 19, the gripper 411R and the gripper 412R can grip the ball 402 in such a way as to cover the ball 402 from both sides.

Note that, for example, the tube 425R and the tube 435R may be connected to one pneumatic source, and the gripper 411R and the gripper 412R may be simultaneously flexed or extended.

### <Seventh Modification of Hand>

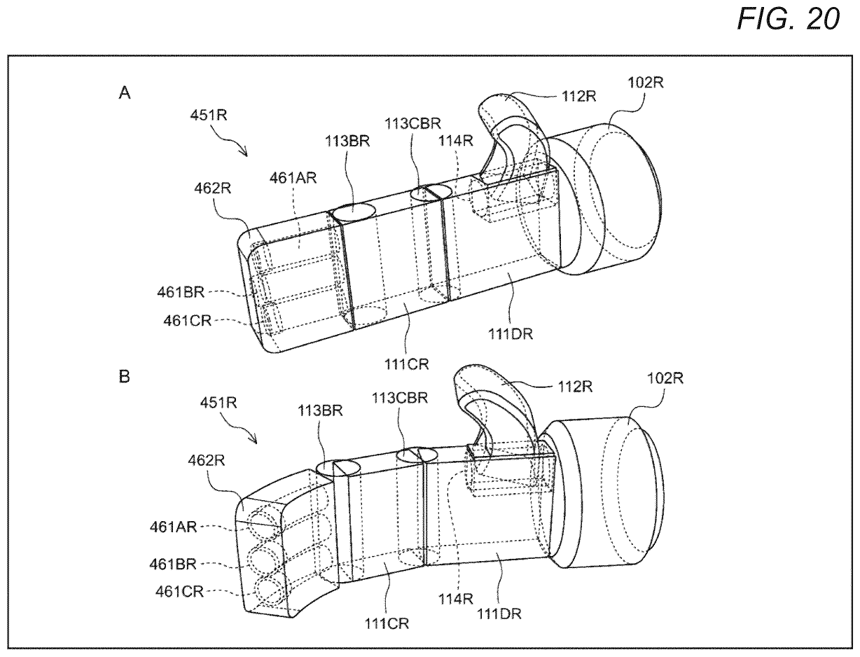

Next, a seventh modification of the hand of the nursing care robot 11 will be described with reference to FIG. 20.

FIG. 20 schematically illustrates a configuration example of an appearance of a hand 451R corresponding to the right hand of the nursing care robot 11. A of FIG. 20 illustrates a state in which the hand 451R is open. B of FIG. 19 illustrates a state in which a tip of a main portion of the hand 451R is bent. Note that, in the drawing, portions corresponding to those of the hand 101R in FIGS. 10 to 12 are given the same reference numerals, and description thereof is omitted as appropriate.

The seventh modification is a combination of the first modification and the third modification.

Specifically, the hand 451R is different in that pneumatic bending actuators 461AR to 461CR and an exterior 462R are provided instead of the part 111AR, the part 111BR, and the actuator 113AR.

In a case where it is not necessary to individually distinguish the pneumatic bending actuators 461AR to 461CR, they will be simply referred to as the pneumatic bending actuators 461R hereinafter.

One ends of the pneumatic bending actuators 461R are connected to an actuator 113BR, extend in the z-axis direction, and are arranged side-by-side in the y-axis direction.

Each pneumatic bending actuator 461R is covered with the exterior 462R. A material similar to that of the exterior 214R in FIG. 14 is used for the exterior 462R.

Each pneumatic bending actuator 461R is connected to a pneumatic branching unit, a tube, and a pneumatic source (not illustrated). Each pneumatic bending actuator 461R and the exterior 462R can be flexed and extended in the pitch direction.

In addition, the actuator 113BR rotates each pneumatic bending actuator 461R and the exterior 462R in the pitch direction with respect to a part 111CR to move the pneumatic bending actuator 461R and the exterior 462R closer to the part 111CR or away from the part 111CR. As a result, a portion of the hand 451R corresponding to the PIP joints of the index to little fingers can be flexed and extended in the pitch direction.

As a result, a degree of freedom of a shape of a portion of the hand 451R corresponding to distal sections of the index to little fingers improves.

### <Other Modifications of Hand of Nursing Care Robot 11>

For example, in the first modification, the number of pitch axes for flexing and extending the main portion of the hand 101R may be four or more.

For example, in the third to fifth and seventh modifications, the number of pneumatic bending actuators of the main portion may be two or four or more.

For example, in the sixth modification, the number of pneumatic bending actuators of each gripper may be two or four or more.

For example, in the third to seventh modifications, it is possible to use bending actuators that use a pressure (for example, hydraulic pressure or water pressure) other than air pressure.

### <Other Modifications>

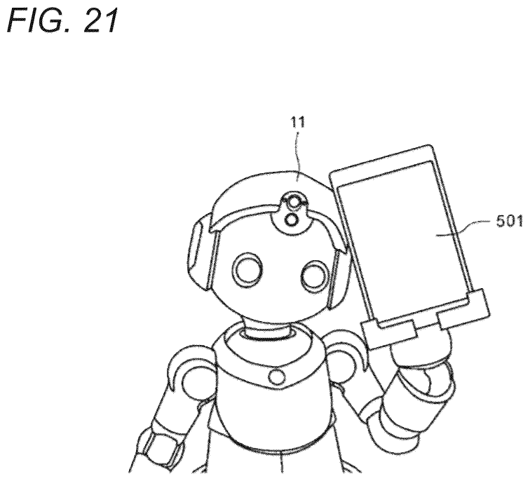

For example, as illustrated in FIG. 21, a hand display 501 can be mounted on the hand of the nursing care robot 11. In this case, for example, a hand capable of forming a flat surface on a palm side as in the first to fourth and seventh modifications of the hand of the nursing care robot 11 described above can be used to grip the hand display 501 in a natural posture.

The robot hand mechanism in the present technology, that is, a mechanism of the hand of the nursing care robot 11 described above, can be employed for various robots including a hand mechanism imitating a human hand. For example, the robot hand mechanism in the present technology can be employed for a robot including only an arm, such as a manipulator.

### «3. Others»

Embodiments of the present technology are not limited to the embodiments described above, and various modifications can be made without departing from the scope of the present technology.

For example, the present technology may be embodied in cloud computing in which one function is shared and processed by a plurality of apparatuses in cooperation via a network.

### <Examples of Combinations of Configurations>

The present technology can also be configured as follows.

(1)

A robot hand mechanism including:
a main portion corresponding to a portion other than a thumb of a hand;
a thumb portion corresponding to the thumb;
a first rotation shaft that is parallel to a second direction perpendicular to a first direction in which the main portion extends and that flexes and extends the main portion in a first rotation direction;
a second rotation shaft that is parallel to the first rotation shaft and that flexes and extends the main portion in the first rotation direction; and
a third rotation shaft that is parallel to the first direction or inclined in an oblique direction with respect to the first direction about a third direction perpendicular to the first direction and the second direction and that rotates the thumb portion in a second rotation direction with respect to the main portion, in which
in a state in which the main portion is extended, the first to third rotation shafts are arranged on a same plane.
   (2)

The robot hand mechanism according to (1), in which
a flat surface is formed on a palm side of the main portion and the thumb portion in a state where the main portion and the thumb portion are open.
   (3)

The robot hand mechanism according to (2), in which
a flat surface is formed on a back side of a hand of the main portion and the thumb portion in a state where the main portion and the thumb portion are open.
   (4)

The robot hand mechanism according to (3), in which
the main portion has a plate shape in an extended state.
   (5)

The robot hand mechanism according to any one of (1) to (4), in which
the first to third rotation shafts are arranged in the main portion.
   (6)

The robot hand mechanism according to (5), in which
the third rotation shaft is arranged near an end portion of the main portion in the second direction.
   (7)

The robot hand mechanism according to (5) or (6), in which
the third rotation shaft is arranged near a base of the main portion.
   (8)

The robot hand mechanism according to any one of (1) to (7), in which
an orientation of the third rotation shaft is within a range of ±45 degrees about an axis in the third direction with respect to the first direction.
   (9)

The robot hand mechanism according to (8), in which
the third rotation shaft is parallel to the first direction.
   (10)

The robot hand mechanism according to any one of (1) to (9), further including:
a fourth rotation shaft that is parallel to the first rotation shaft and the second rotation shaft and that flexes and extends the main portion in the first rotation direction, in which
in the state where the main portion is extended, the first to fourth rotation shafts are arranged on the plane.
   (11)

The robot hand mechanism according to (10), in which
the first to fourth rotation shafts are arranged in the main portion.
   (12)

The robot hand mechanism according to any one of (1) to (11), further including:
a plurality of bending actuators arranged side-by-side in the second direction at a distal end of the main portion and bendable in the first rotation direction.
   (13)

The robot hand mechanism according to any one of (1) to (12), in which
a tip of the main portion and a tip of the thumb portion are contactable with each other.

Note that the effects described in the present specification are merely examples and are not limited, and other effects may be provided.

### REFERENCE SIGNS LIST

11 Nursing care robot
63L, 63R Hand
101R Hand
111AR to 111DR, 112R Part
113AR to 113CR, 114R Actuator
115AR to 115CR Tactile sensor
151R Hand
201R Hand
211R Part
212R Pneumatic branching unit
213AR to 213CR Pneumatic bending actuator
214R Exterior
215R Part
216R Actuator
217R Tube
218R, 219R Distance sensor
220R Pneumatic sensor
301R Hand
311R, 312R Part
351R Hand
361R Part
362R Pneumatic bending actuator
363R Actuator
401R Hand
411R 412R Gripper
413R Part
421R Part
422R Pneumatic branching unit
423AR to 423CR Pneumatic bending actuator
424R Flexible cover
425R Tube
431R Part
432R Exterior
433AR to 433CR Pneumatic bending actuator
434R Exterior
435R Tube
501 Hand display

1. A robot hand mechanism comprising:
a main portion corresponding to a portion other than a thumb of a hand;
a thumb portion corresponding to the thumb;
a first rotation shaft that is parallel to a second direction perpendicular to a first direction in which the main portion extends and that flexes and extends the main portion in a first rotation direction;
a second rotation shaft that is parallel to the first rotation shaft and that flexes and extends the main portion in the first rotation direction; and
a third rotation shaft that is parallel to the first direction or inclined in an oblique direction with respect to the first direction about a third direction perpendicular to the first direction and the second direction and that rotates the thumb portion in a second rotation direction with respect to the main portion, wherein
in a state in which the main portion is extended, the first to third rotation shafts are arranged on a same plane.

2. The robot hand mechanism according to claim 1, wherein
a flat surface is formed on a palm side of the main portion and the thumb portion in a state where the main portion and the thumb portion are open.

3. The robot hand mechanism according to claim 2, wherein
a flat surface is formed on a back side of a hand of the main portion and the thumb portion in a state where the main portion and the thumb portion are open.

4. The robot hand mechanism according to claim 3, wherein
the main portion has a plate shape in an extended state.

5. The robot hand mechanism according to claim 1, wherein
the first to third rotation shafts are arranged in the main portion.

6. The robot hand mechanism according to claim 5, wherein
the third rotation shaft is arranged near an end portion of the main portion in the second direction.

7. The robot hand mechanism according to claim 5, wherein
the third rotation shaft is arranged near a base of the main portion.

8. The robot hand mechanism according to claim 1, wherein
an orientation of the third rotation shaft is within a range of ±45 degrees about an axis in the third direction with respect to the first direction.

9. The robot hand mechanism according to claim 8, wherein
the third rotation shaft is parallel to the first direction.

10. The robot hand mechanism according to claim 1, further comprising:
a fourth rotation shaft that is parallel to the first rotation shaft and the second rotation shaft and that flexes and extends the main portion in the first rotation direction, wherein
in the state where the main portion is extended, the first to fourth rotation shafts are arranged on the plane.

11. The robot hand mechanism according to claim 10, wherein
the first to fourth rotation shafts are arranged in the main portion.

12. The robot hand mechanism according to claim 1, further comprising:
a plurality of bending actuators arranged side-by-side in the second direction at a distal end of the main portion and bendable in the first rotation direction.

13. The robot hand mechanism according to claim 1, wherein
a tip of the main portion and a tip of the thumb portion are contactable with each other.
